(19) United States
(12) Patent Application Publication
(10) Pub. No.: US 2026/0296066 A1
(43) Pub. Date: Oct. 1, 2026

(54) PRINTING DEVICE, PRINTING SYSTEM, SERVER, AND ESTIMATION METHOD

(71) Applicant: SEIKO EPSON CORPORATION, Tokyo (JP)

(72) Inventor: Daisuke YANAGIMACHI, MATSUMOTO-SHI (JP)

(21) Appl. No.: 19/574,530

(22) Filed: Mar. 23, 2026

(30) Foreign Application Priority Data
Mar. 25, 2025 (JP) 2025-049762

(51) Int. Cl. B41J 11/00; B41J 2/32; B41J 3/46; B41J 15/04; B41J 29/13

(52) U.S. Cl. CPC B41J 11/0075; B41J 2/32; B41J 3/46; B41J 15/04; B41J 29/13

(57) ABSTRACT

A printing device includes a storing section capable of storing roll paper and a conveyance section configured to convey the roll paper stored in the storing section. The printing device includes a weight detection section configured to detect a weight change of the roll paper in the storing section at the time when the conveyance section conveys the roll paper by a predetermined length and a remaining amount estimation section configured to estimate a remaining amount of the roll paper based on the weight change detected by the weight detection section.

The present application is based on, and claims priority from JP Application Serial Number 2025-049762, filed Mar. 25, 2025, the disclosure of which is hereby incorporated by reference herein in its entirety.

### BACKGROUND

### 1. Technical Field

The present disclosure relates to a printing device, a printing system, a server, and an estimation method.

### 2. Related Art

There has been known a printing device including a remaining amount detection section that detects a remaining amount of roll paper.

JP-A-2018-144405 discloses a printer that notifies a remaining amount of roll paper based on a measurement value of the length of roll paper printed after the remaining amount of the roll paper becomes equal to or smaller than a threshold and the length of the roll paper from when the remaining amount of the roll paper becomes equal to or smaller than the threshold until when the roll paper runs out.

JP-A-2018-144405 is an example of the related art.

However, in JP-A-2018-144405, since remaining amount estimation is performed using actual values in the past, for example, when the roll paper is replaced with roll paper having a different paper thickness, the remaining amount estimation can be inaccurate.

### SUMMARY

According to an aspect of the present disclosure, there is provided a printing device including: a storing section configured to store roll paper; a conveyance section configured to convey the roll paper stored in the storing section; a first detection section configured to detect a weight change of the roll paper in the storing section at a time when the conveyance section conveys the roll paper by a predetermined length; and a remaining amount estimation section configured to estimate a remaining amount of the roll paper based on the weight change detected by the first detection section.

According to another aspect of the present disclosure, there is provided a printing system including: a first detection section configured to detect a weight change of roll paper at a time when roll paper stored in a printing device is conveyed by a predetermined length; and a remaining amount estimation section configured to estimate a remaining amount of the roll paper based on the weight change detected by the first detection section.

According to still another aspect of the present disclosure, there is provided a server including: a first detection section configured to detect a weight change of roll paper at a time when the roll paper stored in a printing device is conveyed by a predetermined length; and a remaining amount estimation section configured to estimate a remaining amount of the roll paper based on the weight change detected by the first detection section.

According to still another aspect of the present disclosure, there is provided an estimation method including a computer executing: detecting a weight change of roll paper at a time when the roll paper stored in a printing device is conveyed by a predetermined length; and estimating a remaining amount of the roll paper based on the detected weight change.

### BRIEF DESCRIPTION OF THE DRAWINGS

FIG. 1 is a perspective view of a printing device viewed from obliquely above.

FIG. 2 is a side cross-sectional view of the printing device.

FIG. 3 is a front cross-sectional view of the printing device.

FIG. 4 is a diagram illustrating a functional configuration of the printing device.

FIG. 5 is a flowchart of an operation of the printing device.

FIG. 6 is a side cross-sectional view illustrating a structure of a printing device in a second embodiment.

FIG. 7 is a front cross-sectional view illustrating the structure of the printing device in the second embodiment.

FIG. 8 is a diagram illustrating a configuration of a printing system in a fourth embodiment.

### DESCRIPTION OF EMBODIMENTS

Embodiments are explained below with reference to the drawings. In the drawings, for convenience of understanding, members are illustrated in scales different from actual scales.

### 1. First Embodiment

### 1-1. Structure of a Printing Device

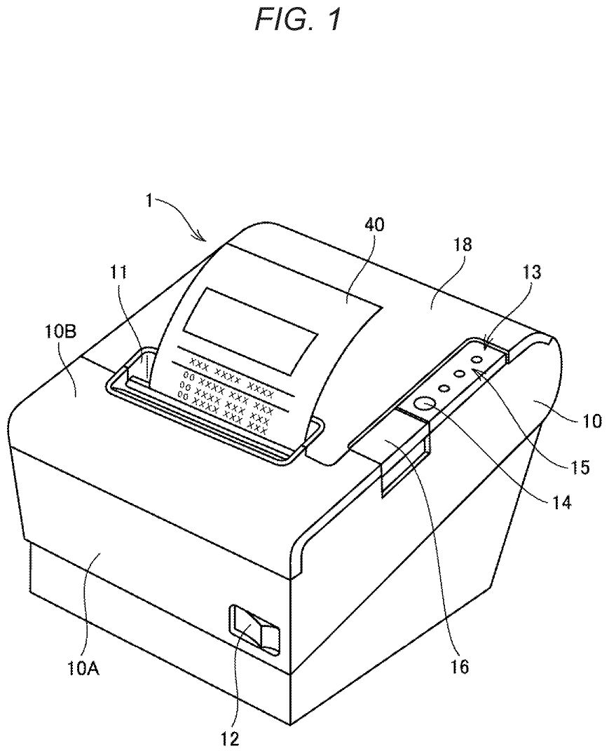

FIG. 1 is a perspective view of a printing device 1 viewed from obliquely above.

A structure of the printing device 1 is explained. The printing device 1 is a register printer installed in a store such as a supermarket, a convenience store, or a restaurant.

FIG. 1 is a perspective view of the printing device 1 viewed from obliquely above. The printing device 1 includes a substantially cubic housing 10.

A storing section 42 that stores roll paper 40 is provided on the inside of the housing 10. The storing section 42 is explained below.

A power switch 12 for turning on and off the printing device 1 is disposed on a front surface 10A of the housing 10.

A paper discharge port 11 for discharging the roll paper 40 stored in the storing section 42 of the printing device 1 is provided on an upper surface 10B of the housing 10.

A panel 13 is provided on the upper surface 10B of the housing 10. On the panel 13, a push-type print start button 14 for instructing a start of printing of the roll paper 40 is provided. The print start button 14 is provided in a “receiving section”.

On the panel 13, an LED display unit 15 is provided. The LED display unit 15 includes a plurality of LEDs. The LEDs turn on or off in a predetermined mode to thereby notify information concerning the printing device 1 such as an operation mode and an error state of the printing device 1.

A cover 18 is a member that opens and closes an opening for inserting and removing the roll paper 40 into and from the storing section 42.

A lever 16 for opening the cover 18 is provided near the panel 13. The cover 18 can be opened by pushing down the lever 16 when the cover 18 is in a closed state.

Although not illustrated, a mechanical opening and closing sensor or an optical opening and closing sensor that detects opening and closing of the cover 18 is installed near the cover 18.

In the printing device 1 illustrated in FIG. 1, the paper discharge port 11 is present on an upper surface 10B side of the housing 10. However, the paper discharge port 11 may be provided on a front surface 10A side.

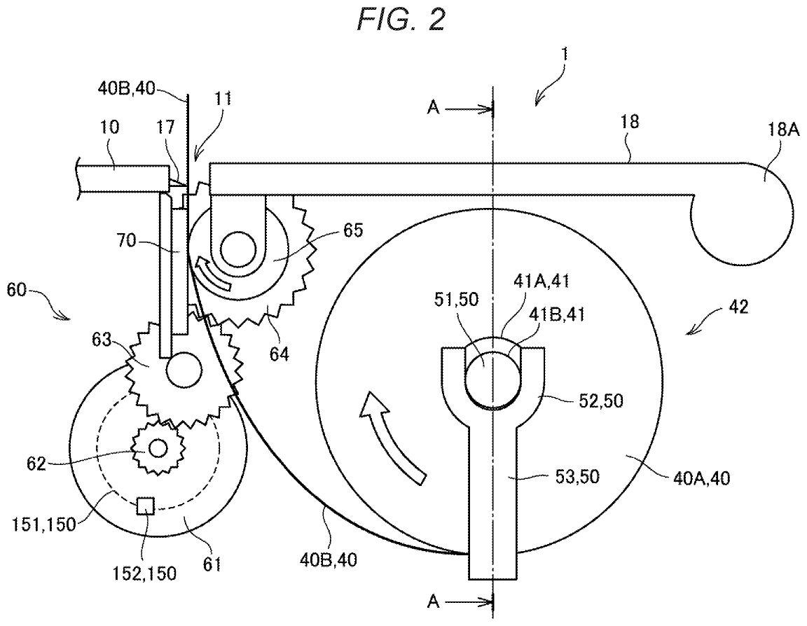

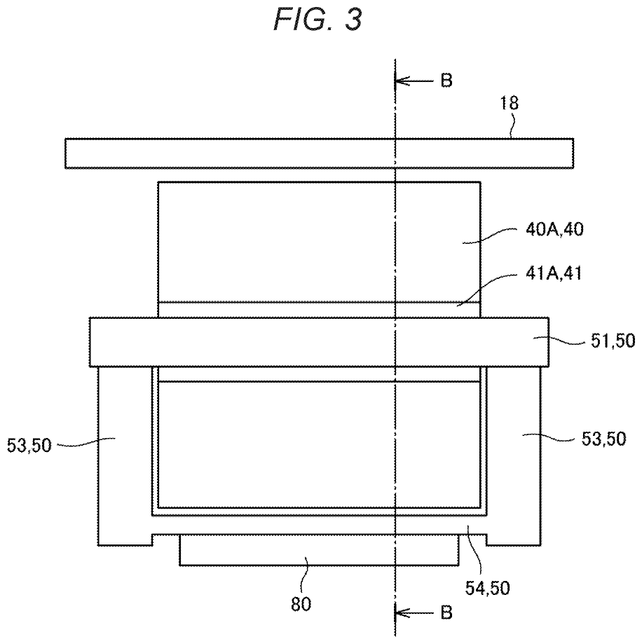

FIG. 2 is a side cross-sectional view of the printing device 1 in the present embodiment. FIG. 3 is a front cross-sectional view of the printing device 1 in the present embodiment. FIG. 2 is a B-B arrow view of FIG. 3. FIG. 3 is an A-A arrow view of FIG. 2.

Hereinafter, an internal structure of the housing 10 of the printing device 1 is explained with reference to FIGS. 2 and 3.

First, a structure for storing the roll paper 40 is explained.

The roll paper 40 includes a roll portion 40A obtained by winding a print medium, which is continuous paper, around a cylindrical winding core 41 and a belt portion 40B pulled out from the roll portion 40A. The belt portion 40B is sandwiched by a platen 65 and a thermal head 70. In the sandwiched part, printing is performed by the thermal head 70. The print medium used in the roll paper 40 is thermal paper.

The winding core 41 has an outer circumferential wall 41A and an inner circumferential wall 41B.

The storing section 42 is a space formed in the housing 10 capable of storing the roll portion 40A. In the present embodiment, the roll portion 40A is rotatably pivotally supported by a pivotal support member 50 together with the winding core 41 and is stored in the storing section 42.

The cover 18 is located on the upper side of the storing section 42 and is capable of turning with a center axis of a columnar section 18A as a fulcrum. When the cover 18 is opened, an opening for inserting and removing the roll paper 40 into and from the storing section 42 is formed in the upper surface 10B of the housing 10.

Here, a structure of the pivotal support member 50 is explained.

The pivotal support member 50 includes a shaft 51, a pair of bearings 52, 52, a pair of legs 53, 53, and a coupling section 54.

The shaft 51 has a cylindrical shape and the cylindrical winding core 41 can be attached thereto.

The pair of bearings 52, 52 respectively supports one end and the other end of the shaft 51 from below. The bearings 52 have a semi-cylindrical shape opened on the upper side.

The pair of legs 53, 53 respectively supports the pair of bearings 52, 52.

The coupling section 54 couples lower portions of the pair of legs 53, 53.

In the pivotal support member 50, the pair of bearings 52, 52, the pair of legs 53, 53, and the coupling section 54 are integrally formed.

The roll portion 40A is stored in the storing section 42 while being rotatably pivotally supported by the pivotal support member 50 explained above.

Next, a structure for detecting the weight of the roll paper 40 is explained.

A weight sensor 80 is disposed below the pivotal support member 50. Specifically, the weight sensor 80 is disposed to support the coupling section 54 of the pivotal support member 50 from below. That is, the roll portion 40A of the roll paper 40, the winding core 41, and the pivotal support member 50 are placed on the weight sensor 80.

A pressure sensor that detects pressure can be used as the weight sensor 80. In the present embodiment, the weight sensor 80 measures a load received from the coupling section 54 of the pivotal support member 50. A measurement value of the weight sensor 80 is output to a weight detection section 111 of a processor 110 explained below. The weight detection section 111 detects the weight of the roll paper based on the measurement value of the weight sensor 80.

With the structure explained above, the weight of the roll paper 40 can be detected with a small number of components. Since the weight sensor 80 is disposed below the pivotal support member 50, the weight of the roll paper 40 can be detected without increasing the size of the printing device 1 in the width direction and the depth direction.

Next, a structure of a conveyance section 60 that conveys the roll paper 40 is explained.

The conveyance section 60 includes a conveyance motor 61, a motor pulley 62, a transmission gear 63, a platen gear 64, and the platen 65.

The conveyance motor 61 is a drive source for conveying the roll paper 40.

The motor pulley 62 is a pulley for transmitting power of a rotor of the conveyance motor 61 to the others. The motor pulley 62 has a gear-shaped cross section.

The transmission gear 63 transmits rotation of the motor pulley 62 to the platen gear 64.

The platen gear 64 transmits rotation of the transmission gear 63 to the platen 65. By these mechanisms, rotation of the conveyance motor 61 is transmitted to the platen 65.

The platen 65 conveys the roll paper 40. Specifically, the platen 65 conveys the belt portion 40B of the roll paper 40 upward by rotating clockwise in FIG. 2 while sandwiching the belt portion 40B of the roll paper 40 in conjunction with the thermal head 70.

The leading end portion of the roll paper 40 conveyed upward with characters and the like printed thereon by the thermal head 70 is discharged from the paper discharge port 11.

In the paper discharge port 11, a cutter 17 for cutting the belt portion 40B of the roll paper 40 is provided.

The printing device 1 includes an encoder 150 for detecting the rotation speed of the conveyance motor 61. The encoder 150 includes a slit group 151 and an optical sensor 152. In the slit group 151, a plurality of slits are annularly provided on the side surface of the conveyance motor 61. The optical sensor 152 includes a light projecting section that projects light toward the side surface of the conveyance motor 61 and a light receiving section that receives reflected light from the slit group 151. When light is projected to the rotating conveyance motor 61, pulse-shaped reflected light corresponding to the slits of the slit group 151 is obtained. Accordingly, the rotation speed of the conveyance motor 61 is detected.

The thermal head 70 sandwiches the belt portion 40B of the conveyed roll paper 40 in conjunction with the platen 65. Dots are formed by heat generating elements on the sandwiched portion of the belt portion 40B to print characters and the like.

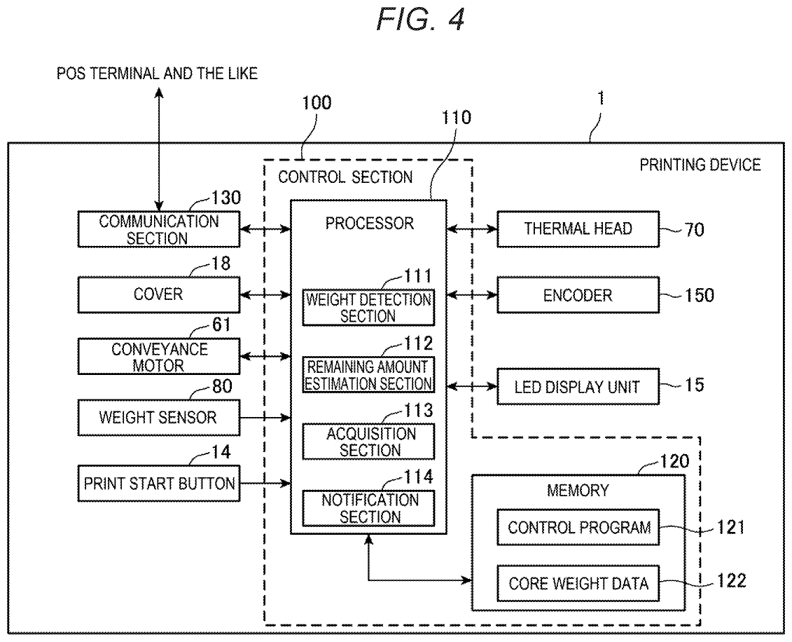

FIG. 4 is a block diagram illustrating a functional configuration of the printing device 1.

The printing device 1 includes the processor 110 and a memory 120 as a control section 100.

The processor 110 includes a central processing unit (CPU) or a micro-processing unit (MPU). The processor 110 controls the sections of the printing device 1. As an example, the processor 110 controls a communication section 130, the thermal head 70, the conveyance motor 61, the LED display unit 15, and the like. The processor 110 is also connected to the opening and closing sensor of the cover 18 and the print start button 14 and detects input from the opening and closing sensor and the print start button 14.

The memory 120 is an example of a “storage section”.

The memory 120 is a device that stores programs and data. The memory 120 stores a control program 121 and core weight data 122. The memory 120 also stores data to be processed by the processor 110, a program for controlling the sections of the printing device 1, and the like.

The memory 120 includes a nonvolatile storage area. The memory 120 also includes a volatile storage area and configures a work area of the processor 110. The memory 120 includes, for example, a read only memory (ROM) or a random access memory (RAM).

The core weight data 122 is data concerning the weight of the winding core 41 of the roll paper 40.

The core weight data 122 is registered in the memory 120, for example, by input from a POS terminal connected to the printing device 1, a server 2 explained below, or the like. When the printing device 1 includes an operation input section capable of inputting characters, the core weight data 122 may be input from the operation input section.

The weight of the pivotal support member 50 is also registered in the memory 120.

The processor 110 functions as the weight detection section 111, a remaining amount estimation section 112, an acquisition section 113, and a notification section 114 by reading and executing the control program 121 stored by the memory 120.

The weight detection section 111 detects a change in the weight of the roll paper 40 at the time when the conveyance section 60 conveys the roll paper 40 by a predetermined length. In the present embodiment, the weight detection section 111 detects a change in the weight of the roll paper 40 based on a measurement value of the weight sensor 80.

The weight detection section 111 is an example of a “first detection section”.

Hereinafter, the change in the weight of the roll paper 40 is referred to as “weight change” as appropriate.

The weight detection section 111 detects the weight of the roll paper 40 in the storing section 42. As explained above, the weight sensor 80 measures not only the weight of the roll portion 40A of the roll paper 40 but also the weight of the winding core 41 and the pivotal support member 50. Thus, the weight detection section 111 subtracts information concerning the weight of the winding core 41 and the pivotal support member 50 from the measurement value of the weight sensor 80 to detect the weight of the roll paper 40. The information concerning the weight of the winding core 41 and the pivotal support member 50 is registered in the memory 120 in advance. When the weight of the roll paper 40 is detected, the information is read from the memory 120.

The weight detection section 111 is also an example of a “second detection section”.

The remaining amount estimation section 112 estimates a remaining amount of the roll paper 40 based on the weight change of the roll paper 40 detected by the weight detection section 111. Specifically, the remaining amount estimation section 112 estimates a remaining amount of the roll portion 40A, which is an unprinted portion of the roll paper 40. A procedure for estimating the remaining amount is explained below.

The acquisition section 113 acquires the weight of the winding core 41 of the roll paper 40. The weight of the winding core 41 is acquired with reference to, for example, the core weight data 122 stored in the memory 120.

The notification section 114 notifies the remaining amount of the roll paper 40. In particular, the notification section 114 performs the notification when the remaining amount of the roll paper 40 is equal to or smaller than a predetermined value.

For example, the notification section 114 notifies an estimated value of the remaining amount of the roll paper 40 estimated by the remaining amount estimation section 112. When the weight of the roll paper 40 detected by the weight detection section 111 is equal to or smaller than a predetermined value, the notification section 114 notifies that the remaining amount of the roll paper 40 is small.

Examples of a notification method performed by the notification section 114 include blinking of the LED display unit 15 of the printing device 1 and display on a display of the POS terminal connected to the printing device 1. For example, the notification section 114 blinks the LED display unit 15 of the printing device 1 to thereby notify that the remaining amount of the roll paper 40 is small. The notification section 114 causes a display section of the POS terminal to display the estimated value of the remaining amount of the roll paper 40 to thereby notify the estimated value of the remaining amount of the roll paper 40. Besides, the notification section 114 may perform notification to a computer used by an administrator of a store or notification by voice. In the present embodiment, the blinking of the LED display unit 15 of the printing device 1 is preferentially performed as the notification performed by the notification section 114.

The communication section 130 includes communication hardware such as a communication circuit and communicates with the POS terminal, the server, and the computer used by the administrator of the store according to control by the control section 100.

### 1-2. Operation of the Printing Device

Next, operations of the sections of the printing device 1 in the present embodiment are explained.

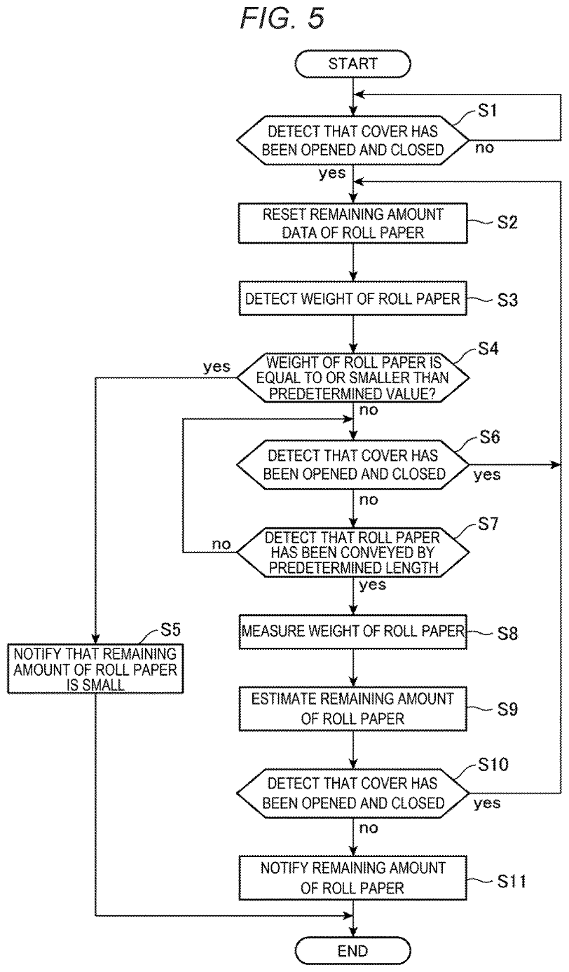

FIG. 5 is a flowchart illustrating an operation of the processor 110 of the printing device 1.

In step S1, the processor 110 detects whether the cover 18 has been opened and closed. The processor 110 detects the opening and closing of the cover 18 based on input from the opening and closing sensor explained above.

The cover 18 is opened and closed, for example, when the user stores the roll paper 40 in the storing section 42. The roll paper 40 referred to here may be new roll paper or half-used roll paper. The roll paper 40 may be roll paper stored in the storing section 42 again after a paper jam occurred during printing and work of removing a paper jam part has been performed.

When the processor 110 detects the opening and closing of the cover 18 (step S1: YES), the processing proceeds to step S2.

In step S2, the remaining amount estimation section 112 resets remaining amount data, which is the estimated value of the remaining amount of the roll paper 40.

When the cover 18 is opened and closed and, for example, the roll paper 40 is replaced with the new roll paper 40, since the remaining amount data of the roll paper 40 estimated in the past is unnecessary, the remaining amount data of the roll paper 40 is reset.

In step S3, the processor 110 detects the weight of the roll paper 40.

Specifically, the weight detection section 111 detects the weight of the roll paper 40 based on the measurement value of the weight sensor 80. For example, the weight detection section 111 subtracts the weight of the pivotal support member 50 and the winding core 41 from the measurement value of the weight sensor 80 to detect the weight of the roll paper 40.

In step S4, the processor 110 determines whether the weight of the roll paper 40 is equal to or smaller than a predetermined value.

The determination of whether the weight is equal to or smaller than the predetermined value may be based on the measurement value of the weight sensor 80 besides being based on the weight value of the roll paper 40.

When it is determined in step S4 that the weight of the roll paper 40 is equal to or smaller than the predetermined value (step S4: YES), the processing proceeds to step S5.

In step S5, the processor 110 notifies that the remaining amount of the roll paper 40 is small. The notification section 114 performs this notification. When step S5 has ended, the processor 110 ends this flow.

That is, when it is determined as YES in step S4, remaining amount estimation processing for the roll paper 40 in step S6 and subsequent steps is not performed. This is because, when the weight of the roll paper 40 is small, if the remaining amount estimation processing in step S6 and subsequent steps is performed, the roll paper 40 sometimes runs out while the conveyance section 60 conveys the roll paper 40 by the predetermined length.

In this case, it is considered that the performing the notification should be more prioritized than performing the estimation processing for the remaining amount of the roll paper 40 such that the administrator or the like of the printing device 1 can quickly prepare the new roll paper 40.

Thus, when it is determined as YES in step S4, the processing in step S5 is performed.

On the other hand, when it is determined in step S4 that the weight of the roll paper 40 is not equal to nor smaller than the predetermined value (step S4: NO), the processor 110 instructs the conveyance motor 61 to be driven to convey the roll paper 40. Thereafter, the processing proceeds to step S6.

In step S6, the processor 110 detects whether the cover 18 has been opened and closed. When opening and closing of the cover 18 has been detected (step S6: YES), the processing returns to step S2. When opening and closing of the cover 18 has not been detected (step S6: NO), the processing proceeds to step S7.

In step S7, the processor 110 detects whether the roll paper 40 has been conveyed by a predetermined length.

Whether the roll paper 40 has been conveyed by the predetermined length can be determined by calculating a conveyance length from rotation speed of the conveyance motor 61 obtained from the encoder 150. The predetermined length can be set to, for example, 1 [m].

Here, a reason why the processing returns to step S2 without proceeding to step S7 when the opening and closing of the cover 18 has been detected in step S6 is explained.

A paper jam of the roll paper 40 is conceivable as a situation in which the cover 18 is opened and closed during printing of the roll paper 40. At this time, the user is considered to open the cover 18 and, for example, manually pull the roll paper 40 to remove a paper jam portion. Accordingly, the roll paper 40 is conveyed, although the conveyance motor 61 is not rotating. Then, erroneous detection occurs in step S7 of calculating a conveyance length from the rotation speed of the conveyance motor 61.

Thus, when the opening and closing of the cover 18 has been detected in step S6, the processing does not proceed to step S7 and returns to step S2, the remaining amount data of the roll paper 40 is reset, and the processing in step S3 and subsequent steps is performed again.

When it is detected in step S7 that the roll paper 40 has been conveyed by the predetermined length (step S8: YES), the processing proceeds to step S8.

In step S8, the processor 110 detects the weight of the roll paper 40. A method of detecting the weight of the roll paper 40 is the same as that in step S3.

In step S9, the processor 110 estimates a remaining amount of the roll paper 40. The remaining amount estimation section 112 estimates the remaining amount of the roll paper 40.

A procedure for estimating a remaining amount of the roll paper 40 is explained below.

Here, the weight of the roll paper 40, which is stored in the storing section 42, detected in step S3 is represented as A [g]. A weight change of the roll paper 40 at the time when the roll paper 40 is conveyed by X [m] is represented as Y [g].

In this case, the weight change of the roll paper 40 per conveyance length of 1 [m] is Y/X [g/m].

The weight of the remaining roll paper 40 is A-Y [g].

Therefore, a remaining printable amount P [m] is as indicated by Expression (1). P=(A−Y)/(Y/X) (1).

By performing such calculation, a remaining amount of the roll paper 40 can be estimated.

When estimating the remaining printable amount P, if it is necessary to consider the weight B [g] of the winding core 41 as well, the remaining printable amount P can be calculated using Expression (2) instead of Expression (1) described above. P=(A−B−Y)/(Y/X) (2).

As information concerning the weight B of the winding core 41, for example, the core weight data 122 recorded in the memory 120 is used.

In step S10, the processor 110 detects whether the cover 18 has been opened and closed. When opening and closing of the cover 18 has been detected (step S11: YES), the processing returns to step S2. That is, when the cover 18 has been opened and closed during the calculation of the remaining amount value of the roll paper 40 after the roll paper 40 is conveyed by the predetermined length, the remaining amount data of the roll paper 40 is reset.

A reason why the processing returns to step S2 when the opening and closing of the cover 18 has been detected is explained.

The estimated value of the remaining amount calculated in step S10 is an estimated value based on a conveyance amount before a paper jam occurs. On the other hand, after the paper jam has occurred, an actual remaining amount of the roll paper 40 is reduced by work of removing a paper jam portion. In this case, when the processing proceeds to step S11 as it is, a wrong estimated value of the remaining amount is notified.

Thus, when the opening and closing of the cover 18 has been detected in step S10, the processing returns to step S2 without proceeding to step S11. Then, the processing in step S3 and subsequent steps is performed again.

In step S11, the processor 110 notifies the remaining amount of the roll paper 40.

The notification section 114 notifies the remaining amount of the roll paper 40 based on the remaining amount value of the roll paper 40 estimated by the remaining amount estimation section 112.

In step S5, when the remaining amount of the roll paper 40 is small, the remaining amount of the roll paper 40 is notified. In step S11, the remaining amount of the roll paper 40 may be notified regardless of whether the remaining amount of the roll paper 40 is small.

This is because, for example, when the printing device 1 is used for an unmanned cash register, there is a possibility that an employee of the store does not immediately notice even if the remaining amount is small. Regardless of whether the remaining amount of the roll paper 40 is small, the roll paper 40 can be prevented from running out if the information concerning the remaining amount of the roll paper 40 is notified early.

In step S7, the processor 110 detects whether the roll paper 40 has been conveyed by 1 [m] as the predetermined length. However, the predetermined length may be length other than 1 [m].

When the remaining amount of the roll paper 40 is estimated again in step S11 and subsequent steps, the remaining amount can be estimated from the weight of the roll paper 40 detected in step S3 and step S8 and the rotation speed of the conveyance motor 61 in step S7 and subsequent steps. That is, it is unnecessary to detect the weight of the roll paper 40 again and the remaining amount of the roll paper 40 can be estimated if the rotation speed of the conveyance motor 61 in step S7 and subsequent steps is detected.

### 1-3. Configuration and Effects

As explained above, the printing device 1 includes the storing section 42 capable of storing the roll paper 40 and the conveyance section 60 that conveys the roll paper 40 stored in the storing section 42. The printing device 1 includes the weight detection section 111 that detects a weight change of the roll paper 40 in the storing section 42 at the time when the conveyance section 60 conveys the roll paper 40 by the predetermined length and the remaining amount estimation section 112 that estimates a remaining amount of the roll paper 40 based on the weight change detected by the weight detection section 111.

Accordingly, by estimating the remaining amount of the roll paper 40 based on both of the weight change and the conveyance amount, the remaining amount of the roll paper 40 can be accurately estimated even when the roll paper 40 is replaced with roll paper having a different paper thickness.

The printing device 1 also includes the memory 120 that stores the weight of the winding core 41 of the roll paper 40. The remaining amount estimation section 112 estimates the remaining amount based on the weight change detected by the weight detection section 111 and the weight of the winding core 41 stored by the memory 120.

By estimating the remaining amount based on the weight of the winding core 41 as well, the remaining amount of the roll paper 40 can be accurately estimated even when the roll paper 40 having the same winding core 41 and having different paper thicknesses is used.

The printing device 1 includes the cover 18 that opens and closes the storing section 42. The remaining amount estimation section 112 resets an estimated value of the remaining amount when the cover 18 is opened and closed.

By resetting the estimated value of the remaining amount in association with the opening and closing of the cover 18, it is possible to prevent a remaining amount of the roll paper 40 from being erroneously estimated, for example, when a paper jam has occurred during the remaining amount estimation processing or when the used roll paper 40 is set in the storing section 42 anew.

The printing device 1 also includes the weight detection section 111 that detects the weight of the roll paper 40 in the storing section 42 and the notification section 114. When the cover 18 is opened and closed, the weight detection section 111 detects the weight. When the weight detected by the weight detection section 111 is equal to or smaller than the predetermined value, the notification section 114 notifies that the remaining amount is small.

When the weight of the roll paper 40 is small, the roll paper 40 is likely to run out while the weight detection section 111 is performing processing of detecting a change in the weight of the roll paper 40 at the time when the roll paper 40 is conveyed by the predetermined length. Thus, by performing the notification when the weight of the roll paper 40 is equal to or smaller than the predetermined value, it is possible to prevent the roll paper 40 from running out while the processing of detecting the change in the weight of the roll paper 40 is performed.

The printing device 1 includes the pivotal support member 50 that rotatably pivotally supports the roll paper 40 stored in the storing section 42 and the weight sensor 80 provided below the pivotal support member 50. The weight sensor 80 measures a load received from the pivotal support member 50. The weight detection section 111 detects a change in the weight of the roll paper 40 based on the load measured by the weight sensor 80.

Accordingly, since the weight sensor 80 is disposed below the pivotal support member 50 that pivotally supports the roll paper 40, it is possible to detect a change in the weight of the roll paper 40 with a configuration in which an increase in the size of the printing device 1 is suppressed.

### 2. Second Embodiment

### 2-1. Structure of a Printing Device

Next, a structure of the printing device 1 in a second embodiment is explained.

In the printing device 1 in the first embodiment, the roll paper 40 stored in the storing section 42 is pivotally supported using the pivotal support member 50. The weight sensor 80 is provided below the pivotal support member 50. In the printing device 1 in the second embodiment, the roll paper 40 is supported using a support member 90 instead of the pivotal support member 50. The weight sensor 80 is provided below the support member 90. In this respect, the structure of the printing device 1 in the second embodiment is different from the structure of the printing device 1 in the first embodiment.

Since configurations of the other sections are the same as the configurations of the sections in the first embodiment, the sections are denoted by the same reference numerals and signs and detailed explanation of the sections is omitted.

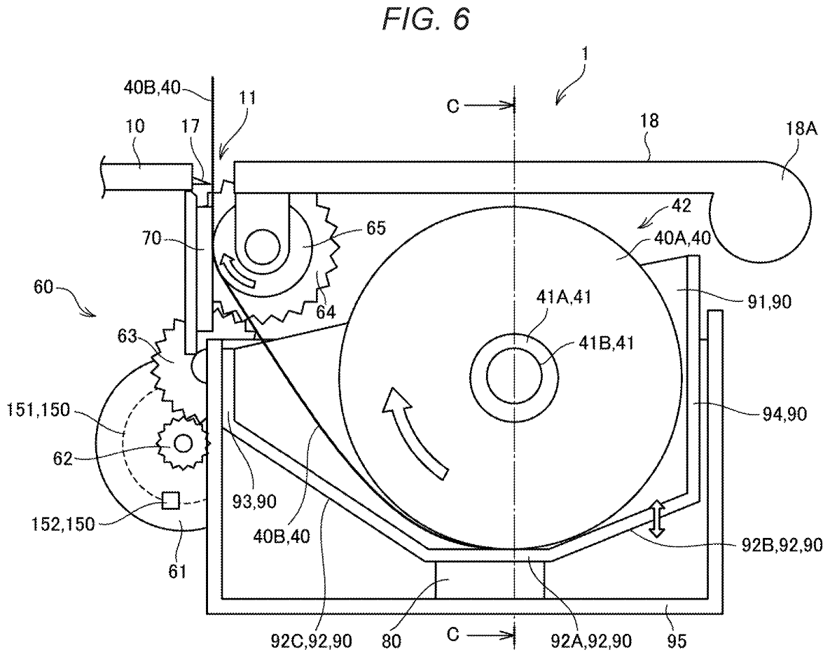

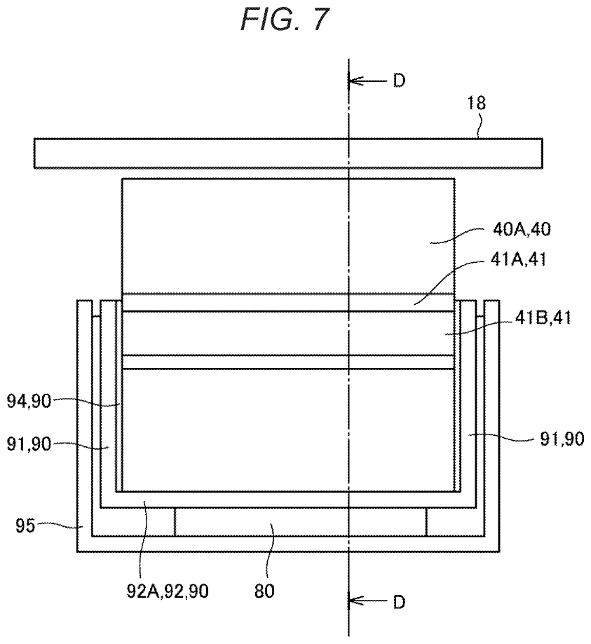

FIG. 6 is a side cross-sectional view of the printing device 1 in the present embodiment. FIG. 7 is a front cross-sectional view of the printing device 1 in the present embodiment. FIG. 6 is a D-D arrow view of FIG. 7. FIG. 7 is a C-C arrow view of FIG. 6.

A structure of the support member 90 is explained. The support member 90 includes a pair of side walls 91, 91, a bottom plate 92, a front wall 93, and a rear wall 94 and has a vessel shape opened on the upper side.

The bottom plate 92 includes three bottom plates 92A, 92B, and 92C.

The bottom plate 92A is formed horizontally with a bottom plate of the not-illustrated housing 10.

The bottom plate 92B is formed to incline with respect to the bottom plate 92A on the back surface side of the bottom plate 92A.

The bottom plate 92C is also formed to incline with respect to the bottom plate 92A. The bottom plate 92C is formed at an inclination angle at which conveyance of the belt portion 40B of the roll paper 40 is not hindered.

As explained above, the support member 90 turnably supports the roll paper 40 from below. Thus, the roll paper 40 can be stably supported.

An attachment member 95 is provided below the support member 90.

The attachment member 95 movably supports the support member 90 from below. The pair of side walls 91, 91, the front wall 93, and the rear wall 94 configuring the support member 90 are guided by the inner side wall of the attachment member 95 and supported to be movable in the vertical direction.

The attachment member 95 has, on the upper side, a first surface that comes into contact with the bottom plate 92B of the support member 90 and a second surface that comes into contact with the bottom plate 92C.

The attachment member 95 can be placed on the bottom plate of the housing 10.

With the configuration explained above, since the support member 90, the attachment member 95, and the weight sensor 80 can be integrally formed as a unit, the weight of the roll paper 40 can be detected with a small number of components.

As in the printing device 1 in the first embodiment, since the weight sensor 80 is disposed below the support member 90, it is possible to measure the weight of the roll paper 40 while suppressing an increase in the size of the printing device 1 in the planar direction.

In the first embodiment, when the roll paper 40 is stored in the storing section 42, work of attaching the winding core 41 to the shaft 51 is necessary. However, according to the second embodiment, the roll paper 40 can be stored in the storing section 42 only by inserting the roll paper 40 from an opening portion of the support member 90.

A functional configuration of the printing device 1 in the second embodiment is the same as the functional configuration of the printing device 1 in the first embodiment. Operations of the sections of the printing device 1 in the second embodiment are the same as the operations of the sections of the printing device 1 in the first embodiment.

### 2-2. Configuration and Effects

As explained above, the printing device 1 in the present embodiment includes the support member 90 that supports the roll paper 40 on the inside of the storing section 42 and the weight sensor 80 provided below the support member 90. The weight sensor 80 measures a load received from the support member 90. The weight detection section 111 detects a change in the weight of the roll paper 40 based on the load measured by the weight sensor 80.

Accordingly, since the roll paper 40 is supported using the support member 90 on the inside of the storing section 42, the roll paper 40 can be stably supported.

### 3. Third Embodiment

Next, the printing device 1 in a third embodiment is explained.

In the printing device 1 in the first embodiment, an example is explained in which the remaining amount data of the roll paper 40 is reset when the opening and closing of the cover 18 is detected. However, in the case of the printing device 1 not including a sensor that detects opening and closing of the cover 18, the operation explained above cannot be performed.

Therefore, in the third embodiment, the remaining amount data of the roll paper 40 is reset when user operation on a receiving section is detected.

As explained above, the receiving section is, for example, the print start button 14. The receiving section may be another button provided in the printing device 1, an input device of a POS terminal connected to the printing device 1, an input device of a computer, or the like.

Except for the above, a structure and an operation of the printing device 1 in the third embodiment are the same as the structure and the operation in the first embodiment and the second embodiment.

As explained above, the printing device 1 in the third embodiment includes the print start button 14 that receives user operation. The remaining amount estimation section 112 resets an estimated value of a remaining amount based on the operation received by the print start button 14.

Accordingly, it is possible to prevent a remaining amount of the roll paper 40 from being erroneously estimated even if an opening and closing sensor that detects opening and closing of the cover 18 is not provided.

### 4. Fourth Embodiment

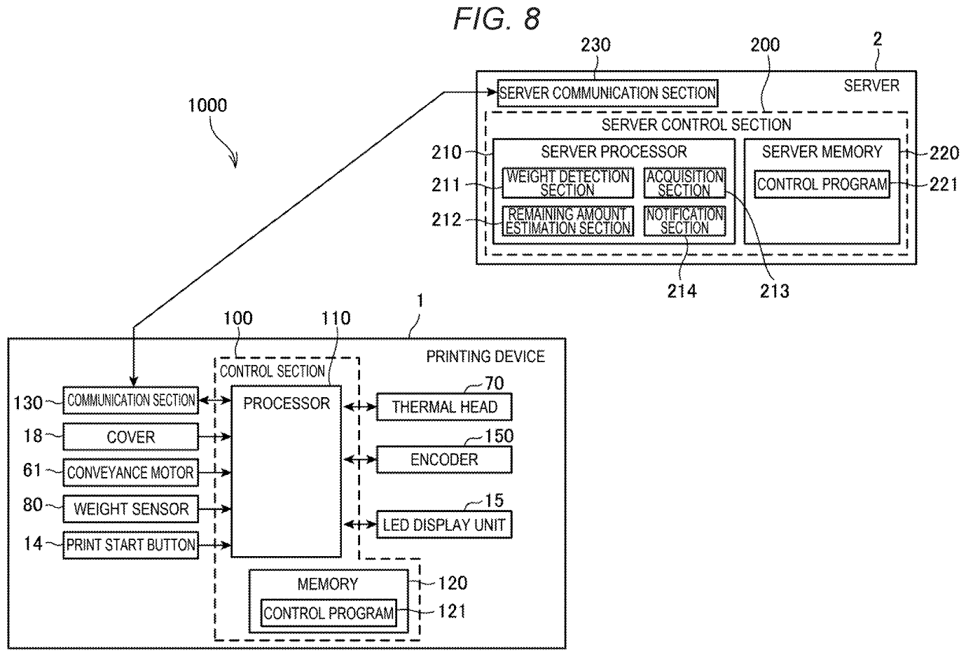

FIG. 8 is a diagram illustrating a configuration of a printing system 1000 in the present embodiment. The printing system 1000 includes the printing device 1 and the server 2.

In the first embodiment, an example is explained in which the processor 110 of the printing device 1 includes the weight detection section 111, the remaining amount estimation section 112, the acquisition section 113, and the notification section 114 as functional sections. The fourth embodiment is different in that, instead of the processor 110 of the printing device 1, a server processor 210 of the server 2 includes these functional sections.

Otherwise, the configuration of the printing device 1 is the same as the configuration of the printing device 1 in the first embodiment. Hereinafter, explanation is omitted as appropriate about the same configuration and the same operation as the configuration and the operation in the first embodiment.

### 4-1. Configuration of the Server

A functional configuration of the server 2 in the present embodiment is explained with reference to FIG. 8.

The server 2 includes the server processor 210 and a server memory 220 as a server control section 200.

The server processor 210 includes a CPU, an MPU, or the like. The server processor 210 controls sections of the server 2.

The server memory 220 is a device that stores programs and data. The server memory 220 stores a control program 221. The server memory 220 also stores data to be processed by the server processor 210, a program for controlling the sections of the server 2, and the like.

The server memory 220 includes a nonvolatile storage area. The server memory 220 also includes a volatile storage area and configures a work area of the server processor 210. The server memory 220 includes, for example, a ROM and a RAM.

The server processor 210 functions as a weight detection section 211, a remaining amount estimation section 212, an acquisition section 213, and a notification section 214 by reading and executing the control program 221 stored by the server memory 220.

The weight detection section 211 detects a change in the weight of the roll paper 40 at the time when the conveyance section 60 of the printing device 1 conveys the roll paper 40 by a predetermined length. The present embodiment is different from the first embodiment in that the weight detection section 211 acquires, through a server communication section 230, data of a measurement value of the weight sensor 80 of the printing device 1 and a conveyance amount of the roll paper by the conveyance section 60. The other processing is the same as the processing of the weight detection section 111 in the first embodiment.

The weight detection section 211 is an example of the “first detection section”. The weight detection section 211 is an example of the “second detection section”.

The remaining amount estimation section 212 estimates a remaining amount of the roll paper 40 based on a weight change detected by the weight detection section 211. Processing performed by the remaining amount estimation section 212 is the same as the processing performed by the remaining amount estimation section 112 in the first embodiment.

The acquisition section 213 acquires the weight of the winding core 41 of the roll paper 40. The acquisition section 213 is different from the acquisition section 113 in the first embodiment in that the acquisition section 213 refers to, through the server communication section 230, the core weight data 122 stored in the memory 120.

The notification section 214 notifies an estimated value of the remaining amount of the roll paper 40. Processing performed by the notification section 214 is the same as the processing performed by the notification section 114 in the first embodiment. However, as a notification method, notification using a display of the server 2 may be preferentially performed.

The server communication section 230 includes communication hardware such as a communication circuit and communicates with the printing device 1 and the like according to control of the server control section 200.

The server control section 200 may be implemented by a plurality of processors or semiconductor chips.

### 4-2. Operation of the Printing System

Next, operations of the sections of the printing system 1000 in the present embodiment are explained.

The operations of the sections of the printing system 1000 are the same as the flow in the first embodiment explained with reference to FIG. 5.

However, in the printing device 1 in the first embodiment, the processor 110 of the printing device 1 performs the processing in step S1 to step S9.

In contrast, in the present embodiment, the processor 110 of the printing device 1 performs the processing in step S1. However, the server processor 210 of the server 2 performs the processing in step S2 and subsequent steps. The present embodiment is different at this point.

### 4-3. Configuration and Effects

As explained above, the printing system 1000 includes the weight detection section 211 and the remaining amount estimation section 212. The weight detection section 211 detects a weight change of the roll paper 40 at the time when the roll paper 40 stored in the printing device 1 is conveyed by the predetermined length. The remaining amount estimation section 212 estimates a remaining amount of the roll paper 40 based on the weight change detected by the weight detection section 211.

Accordingly, by estimating the remaining amount of the roll paper 40 based on both of a weight change amount and the conveyance amount, the remaining amount of the roll paper 40 can be accurately estimated even when the roll paper 40 is replaced with roll paper having a different paper thickness.

The server 2 includes the weight detection section 211 and the remaining amount estimation section 212. The weight detection section 211 detects a weight change of the roll paper 40 at the time when the roll paper 40 stored in the printing device 1 is conveyed by the predetermined length. The remaining amount estimation section 212 estimates a remaining amount of the roll paper 40 based on the weight change detected by the weight detection section 211. The weight detection section 211 is an example of the “first detection section”.

Accordingly, the same effects as the effects of the printing device 1 are achieved.

### 5. Other Embodiments

The embodiments explained above are preferred embodiments of the present disclosure. However, the present disclosure is not limited to the embodiments explained above and various modified implementations are possible without departing from the gist of the present disclosure.

In the embodiment explained above, the processor 110 resets the remaining amount data of the roll paper 40 at the opportunity when the opening and closing sensor detects the opening and closing of the cover 18.

In another embodiment, the remaining amount data of the roll paper 40 may be reset only when it is detected that the cover 18 has been closed.

The remaining amount data of the roll paper 40 may be reset only when a time from when opening of the cover 18 has been detected until when closing of the cover 18 has been detected is equal to or longer than a predetermined time. Here, the predetermined time is, for example, a time required for work of storing the roll paper 40 in the storing section 42. Accordingly, even when the user repeatedly opens and closes the cover 18 intentionally or carelessly, it is possible to prevent the remaining amount data from being repeatedly reset.

In the first embodiment explained above, an example is explained in which the processor 110 of the printing device 1 includes the weight detection section 111, the remaining amount estimation section 112, the acquisition section 113, and the notification section 114 as the functional sections.

In the fourth embodiment, an example is explained in which the server processor 210 of the server 2 includes the weight detection section 211, the remaining amount estimation section 212, the acquisition section 213, and the notification section 214 as the functional sections.

In another embodiment, the processor 110 of the printing device 1 may assume some of these functional sections and the server processor 210 of the server 2 may assume the others.

For example, the processor 110 of the printing device 1 may assume the function of the notification section and the server processor 210 may assume the other functions. Further, both the processor 110 and the server processor 210 may be configured to assume the function of the notification section.

In the embodiments explained above, an example is explained in which the memory 120 of the printing device 1 includes the core weight data 122. In another embodiment, the server memory 220 of the server 2 may include the core weight data.

In the first embodiment, an example is explained in which the acquisition section 113 acquires the value of the weight of the winding core 41 of the roll paper 40 referring to the core weight data 122 stored in the memory 120.

In another embodiment, when the use of the printing device 1 is started, a screen for urging input of core weight may be displayed on, for example, the display of the POS terminal and a value of the core weight may be acquired from input from the POS terminal.

In the second embodiment, the support member 90 not including a shaft to which the winding core 41 of the roll paper 40 is attached is exemplified.

In another embodiment, the support member 90 may include a shaft to which the winding core 41 of the roll paper 40 is attached. With this configuration, since the roll paper 40 is supported by the shaft, the roll paper 40 can be stably supported. Further, it is possible to prevent the roll paper 40 from moving back and forth in the support member 90. For example, in a case of a configuration in which heavy roll paper is stored, since a load due to contact of the roll paper and the bottom plate 92 can be eliminated, it is possible to stably convey the roll paper.

In the embodiments explained above, after detecting that the roll paper 40 has been conveyed by the predetermined length, the processor 110 detects the weight of the roll paper 40 and performs the processing of estimating the remaining amount of the roll paper 40.

In another embodiment, the weight of the roll paper 40 may be detected and the processing of estimating the remaining amount of the roll paper 40 may be performed at the opportunity of a remaining amount estimation instruction from the user.

The control section 100 of the printing device 1 may be implemented by a plurality of processors or semiconductor chips.

In the embodiments explained above, the printing device 1 including the thermal head 70 is exemplified as the “printing device”. However, a printing head provided in the “printing device” is not limited to the thermal head. The print head provided in the “printing device” may be a head of another printing type such as an inkjet head. When the “printing device” includes a print head other than the thermal head, the “conveyance section” may be a conveyance roller or the like that conveys a print medium and is not limited to the platen 65. When the “printing device” includes a print head other than the thermal head, the “roll paper” is not limited to thermal paper and may be, for example, roll paper having a label.

The configurations of the sections of the printing device 1 illustrated in FIGS. 3 and 8 and the configurations of the sections of the server 2 illustrated in FIG. 8 indicate functional configurations and a specific implementation form is not particularly limited. That is, hardware individually corresponding to the functional sections does not always need to be implemented. One processor may execute a program to implement a plurality of functions. Some of functions implemented by software in the embodiments described above may be implemented by hardware and some of functions implemented by hardware in the embodiments may be implemented by software. Besides, specific detailed configurations of the other sections of the printing device 1 and the server 2 can be optionally changed without departing from the gist of the present disclosure.

Processing units of the flowchart illustrated in FIG. 5 are divided according to the main processing contents in order to facilitate understanding of the processing of the sections of the printing device 1. The present disclosure is not limited by a way of division and names of the processing units. The processing units may be divided into a larger number of step units according to the processing contents. One step unit may include many kinds of processing. The order of steps of the processing may be changed as appropriate without causing any problem to the gist of the present disclosure.

What is claimed is:

1. A printing device comprising:
a storing section configured to store roll paper;
a conveyance section configured to convey the roll paper stored in the storing section;
a first detection section configured to detect a weight change of the roll paper in the storing section at a time when the conveyance section conveys the roll paper by a predetermined length; and
a remaining amount estimation section configured to estimate a remaining amount of the roll paper based on the weight change detected by the first detection section.

2. The printing device according to claim 1, further comprising a storage section configured to store weight of a winding core of the roll paper, wherein
the remaining amount estimation section estimates the remaining amount based on the weight change detected by the first detection section and the weight of the winding core.

3. The printing device according to claim 1, further comprising a cover configured to open and close the storing section, wherein
the remaining amount estimation section resets an estimated value of the remaining amount when the cover is opened and closed.

4. The printing device according to claim 1, further comprising a receiving section configured to receive operation of a user, wherein
the remaining amount estimation section resets an estimated value of the remaining amount based on the operation received by the receiving section.

5. The printing device according to claim 3, further comprising:
a second detection section configured to detect weight of the roll paper in the storing section; and
a notification section, wherein
when the cover is opened and closed,
the second detection section detects the weight, and
when the weight detected by the second detection section is equal to or smaller than a predetermined value, the notification section notifies that the remaining amount is small.

6. The printing device according to claim 1, further comprising:
a pivotal support member configured to rotatably pivotally supports the roll paper stored in the storing section; and
a weight sensor provided below the pivotal support member, wherein
the weight sensor measures a load received from the pivotal support member, and
the first detection section detects a change in weight of the roll paper based on the load measured by the weight sensor.

7. The printing device according to claim 1, further comprising:
a support member configured to support the roll paper on an inside of the storing section; and
a weight sensor provided below the support member, wherein
the weight sensor measures a load received from the support member, and
the first detection section detects a change in weight of the roll paper based on the load measured by the weight sensor.

8. A printing system comprising:
a first detection section configured to detect a change in weight of roll paper at a time when roll paper stored in a printing device is conveyed by a predetermined length; and
a remaining amount estimation section configured to estimate a remaining amount of the roll paper based on the change detected by the first detection section.

9. A server comprising:
a first detection section configured to detect a change in weight of roll paper at a time when the roll paper stored in a printing device is conveyed by a predetermined length; and
a remaining amount estimation section configured to estimate a remaining amount of the roll paper based on the change detected by the first detection section.

10. An estimation method comprising a computer executing:
detecting a change in weight of roll paper at a time when the roll paper stored in a printing device is conveyed by a predetermined length; and
estimating a remaining amount of the roll paper based on the detected change.
